(19) United States
(12) Patent Application Publication
(10) Pub. No.: US 2013/0185515 A1
(43) Pub. Date: Jul. 18, 2013

(54) Utilizing Negative Feedback from Unexpected Miss Addresses in a Hardware Prefetcher

(71) Applicants: Peter G. Sassone, Austin, TX (US); Suman Mamidi, Austin, TX (US); Elizabeth Abraham, Austin, TX (US); Suresh K. Venkumahanti, Austin, TX (US); Lucian Codrescu, Austin, TX (US)

(72) Inventors: Peter G. Sassone, Austin, TX (US); Suman Mamidi, Austin, TX (US); Elizabeth Abraham, Austin, TX (US); Suresh K. Venkumahanti, Austin, TX (US); Lucian Codrescu, Austin, TX (US)

(73) Assignee: QUALCOMM INCORPORATED, San Diego, CA (US)

(21) Appl. No.: 13/350,909

(22) Filed: Jan. 16, 2012

(51) Int. Cl. G06F 12/08

(52) U.S. Cl. 711/137; 711/E12.057

(57) ABSTRACT

Systems and methods for populating a cache using a hardware prefetcher are disclosed. A method for prefetching cache entries includes determining an initial stride value based on at least a first and second demand miss address in the cache, verifying the initial stride value based on a third demand miss address in the cache, prefetching a predetermined number of cache entries based on the verified initial stride value, determining an expected next miss address in the cache based on the verified initial stride value and addresses of the prefetched cache entries; and confirming the verified initial stride value based on comparing the expected next miss address to a next demand miss address in the cache. If the verified initial stride value is confirmed, additional cache entries are prefetched. If the verified initial stride value is not confirmed, further prefetching is stalled and an alternate stride value is determined.

### REFERENCE TO CO-PENDING APPLICATIONS FOR PATENT

The present Application for Patent is related to the following co-pending U.S. Patent Applications: “USE OF LOOP AND ADDRESSING MODE INSTRUCTION SET SEMANTICS TO DIRECT HARDWARE PREFETCHING” by Peter Sassone el at., having Attorney Docket No. 111453, filed concurrently herewith, assigned to the assignee hereof, and expressly incorporated by reference herein.

### FIELD OF DISCLOSURE

Disclosed embodiments relate to hardware prefetchers for populating caches. More particularly, exemplary embodiments are directed to hardware prefetchers configured for improved latency, accuracy, and energy by utilizing negative feedback from unexpected cache miss addresses.

### BACKGROUND

Cache mechanisms are employed in modern processors to reduce latency of memory accesses. Caches are conventionally small in size and located close to processors to enable faster access to information such as data/instructions, thus avoiding long access paths to main memory. Populating the caches efficiently is a well recognized challenge in the art. Theoretically, the caches will contain information that is most likely to be used by the corresponding processor. One way to achieve this is by storing recently accessed information under the assumption that the same information will be needed again by the processor. Complex cache population mechanisms may involve algorithms for predicting future accesses, and storing the related information in the cache.

Hardware prefetchers are known in the art for populating caches with prefetched information, i.e. information fetched in advance of the time such information is actually requested by programs or applications running in the processor coupled to the cache. Prefetchers may employ algorithms for speculative prefetching based on memory addresses of access requests or patterns of memory accesses.

Prefetchers may base prefetching on memory addresses or program counter (PC) values corresponding to memory access requests. For example, prefetchers may observe a sequence of cache misses and determine a pattern such as a stride. A stride may be determined based on a difference between addresses for the cache misses, For example, in the case where consecutive cache miss addresses are separated by a constant value, the constant value may be determined to be the stride. If a stride is established, a speculative prefetch may be performed based on the stride and the previously fetched value for a cache miss. Prefetchers may also specify a degree, i.e. a number of prefetches to issue based on a stride, for every cache miss.

While prefetchers may reduce memory access latency if the prefetched information is accurate and timely, implementing the associated speculation is expensive in terms of resources and energy. Moreover, incorrect predictions and prefetches prove to be very detrimental to the efficiency of the processor. Due to limited cache size, incorrect prefetches may also replace correctly populated information in the cache. Conventional prefetchers may include complex algorithms to learn, evaluate, and relearn the patterns such as stride values to determine and improve accuracy of prefetches.

With reference now to FIG. 1, a flow diagram for a prefetch algorithm in a conventional hardware prefetcher is illustrated. Block 102 is a starting point where the prefetcher may be initialized and ready to observe and learn from a new stream of information, such as caches misses for a given PC value. In Block 104, the prefetcher observes a sequence of addresses in the stream and may determine a stride value. Loop 110 indicates that the prefetcher may stay in this learning Block 104 till a predetermined level of confidence may be achieved in the stride value. Once the desired level of confidence is achieved, the prefetcher transitions to the confident Block 106. From confident Block 106, a triggering event such as the next cache miss for the PC value may trigger the transition to prefetch Block 108. At prefetch Block 108, a number N of prefetches based on the desired degree and learned stride will be issued.

The above-described conventional hardware prefetcher algorithm of FIG. 1 suffers from several limitations. Firstly, there is no efficient method of verifying the accuracy of the issued prefetches to potentially relearn a new stride value. For example, utilizing Loop 114 assumes that the stride value is correct and each subsequent cache miss will issue N prefetches with the same stride value, in such implementations, any changes in the stride value will go unobserved and may quickly lead to the cache being populated with unwanted prefetched information.

Alternately, Loop 112 may be used to go back from prefetch Block 108 to learning Block 104 after every issue of N prefetches. This means that the stride value will be relearned on every triggering event such as a cache miss. As can be seen, utilizing Loop 112 can also be highly inefficient and may lead to an undesirably low ratio of cache entries populated by prefetches and cache entries populated by regular demand fetches on a cache miss. In other words, the advantages of using a prefetcher will be significantly reduced.

Accordingly, there is a need in the art for energy-efficient and accurate hardware prefetchers which overcome the aforementioned limitations.

### SUMMARY

Exemplary embodiments of the invention are directed to systems and methods for prefetching entries into a cache.

For example, an exemplary embodiment is directed to method of populating a cache comprising: determining an initial stride value based on at least a first and second demand miss address; verifying the initial stride value based on a third demand miss address: prefetching a predetermined number of cache lines based on the verified initial stride value; determining an expected next miss address based on the verified initial stride value and addresses of the prefetched cache lines; and confirming the verified initial stride value based on comparing the expected next miss address to a next demand miss address.

Another exemplary embodiment is directed to a processing system comprising: a processor; a cache; a memory; and a hardware prefetcher configured to populate the cache by prefetching cache entries from the memory, wherein the hardware prefetcher comprises logic configured to: determine an initial stride value based on at least a first and second demand miss address generated by the processor; verify the initial stride value based on a third demand miss address generated by the processor; prefetch a predetermined number of cache lines based on the verified initial stride value; determine an expected next miss address based on the verified initial stride value and addresses of the prefetched cache lines; and confirm the verified initial stride value based on comparing the expected next miss address to a next demand miss address generated by the processor.

Another exemplary embodiment is directed to a hardware prefetcher for populating a cache, the hardware prefetcher comprising: logic configured to determine an initial stride value based on at least a first and second demand miss address in the cache; logic configured to verify the initial stride value based on a third demand miss address in the cache; logic configured to prefetch a predetermined number of cache lines into the cache based on the verified initial stride value; logic configured to determine an expected next miss address in the cache based on the verified initial stride value and addresses of the prefetched cache lines; and logic configured to confirm the verified initial stride value based on comparing the expected next miss address to a next demand miss address in the cache.

Another exemplary embodiment is directed to a system comprising: a cache; means for determining an initial stride value based on at least a first and second demand miss address in the cache; means for verifying the initial stride value based on a third demand miss address in the cache; means for prefetching a predetermined number of cache lines into the cache, based on the verified initial stride value; means for determining an expected next miss address in the cache based on the verified initial stride value and addresses of the prefetched cache lines; and means for confirming the verified initial stride value based on comparing the expected next miss address to a next demand miss address in the cache.

Yet another exemplary embodiment is directed to a non-transitory computer-readable storage medium comprising code, which, when executed by a processor, causes the processor to perform operations for prefetching entries into a cache, the non-transitory computer-readable storage medium comprising: code for determining an initial stride value based on at least a first and second demand miss address in the cache; code for verifying the initial stride value based on a third demand miss address in the cache; code for prefetching a predetermined number of cache lines into the cache, based on the verified initial stride value; code for determining an expected next miss address in the cache based on the verified initial stride value and addresses of the prefetched cache lines; and code for confirming the verified initial stride value based on comparing the expected next miss address to a next demand miss address in the cache.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a flow diagram for implementing a prefetch algorithm in a conventional hardware prefetcher.

FIG. 2 illustrates a schematic representation of a processing system 200 including a hardware prefetcher configured according to exemplary embodiments.

FIG. 3 illustrates a flow diagram for implementing a prefetch algorithm in a hardware prefetcher configured according to exemplary embodiments.

FIG. 4 relates to an illustrative example of a method of populating a cache with an information stream according to exemplary embodiments.

FIG. 5 illustrates an exemplary wireless communication system 500 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments relate to hardware prefetchers and associated prefetch algorithms, For example, embodiments may check for accuracy of prefetched data and relearn prefetch patterns, such as stride, while avoiding both Loop 114 (i.e. remaining blind to changes in stride value once a stride value has been established, thus populating the cache with unwanted information) and Loop 112 (i.e. excessively relearning the stride even when the stride value has not changed, thus slowing down the prefetcher).

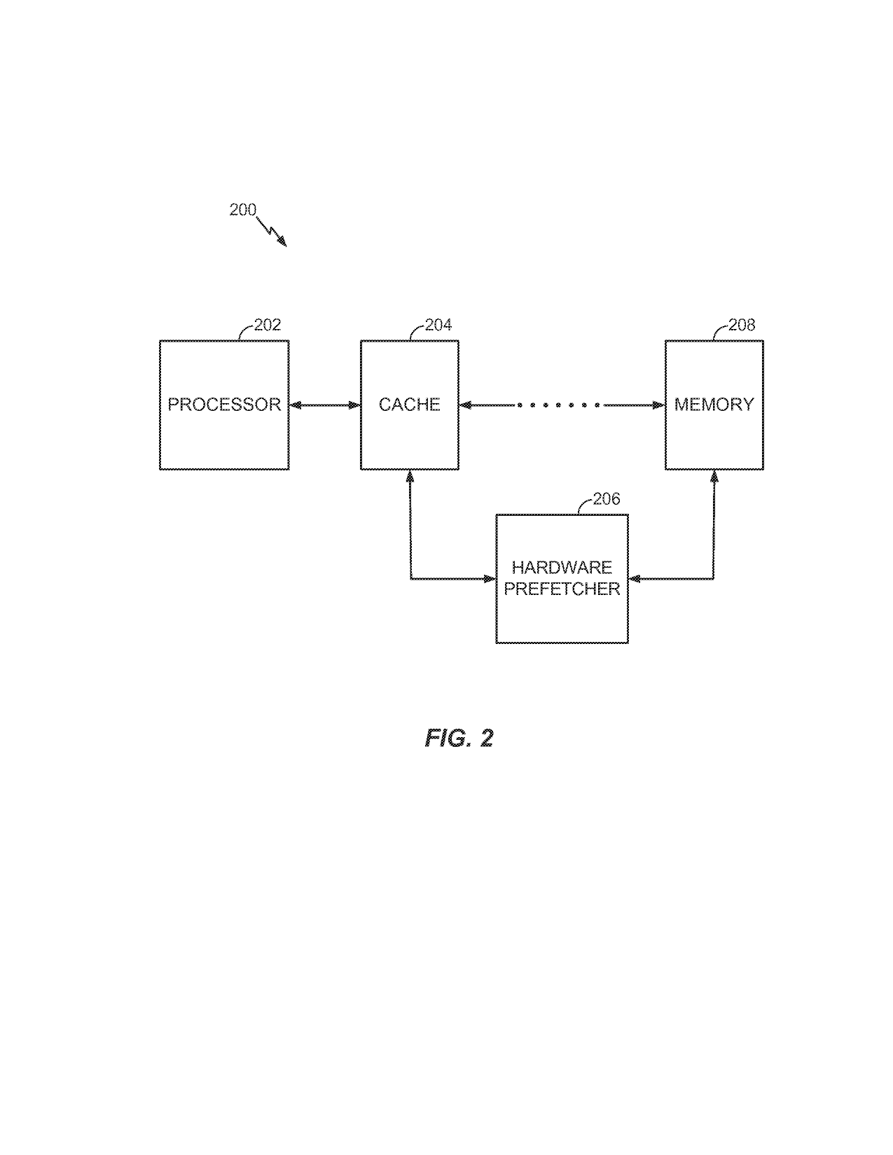

With reference now to FIG. 2, a schematic representation of a processing system 200 including hardware prefetcher 206 configured according to exemplary embodiments is illustrated. As shown, processor 202 may be operatively coupled to cache 204. Cache 204 may be in communication with a memory such as memory 208. While not illustrated, one or more levels of memory hierarchy between cache 204 and memory 208 may be included in processing system 200. Hardware prefetcher 206 may be in communication with cache 204 and memory 208, such that cache 204 may be populated with prefetched information from memory 208 according to exemplary embodiments. The schematic representation of processing system 200 shall not be construed as limited to the illustrated configuration. One of ordinary skill will recognize suitable techniques for implementing the algorithms described with regard to exemplary hardware prefetchers in any other processing environment without departing from the scope of the exemplary embodiments described herein.

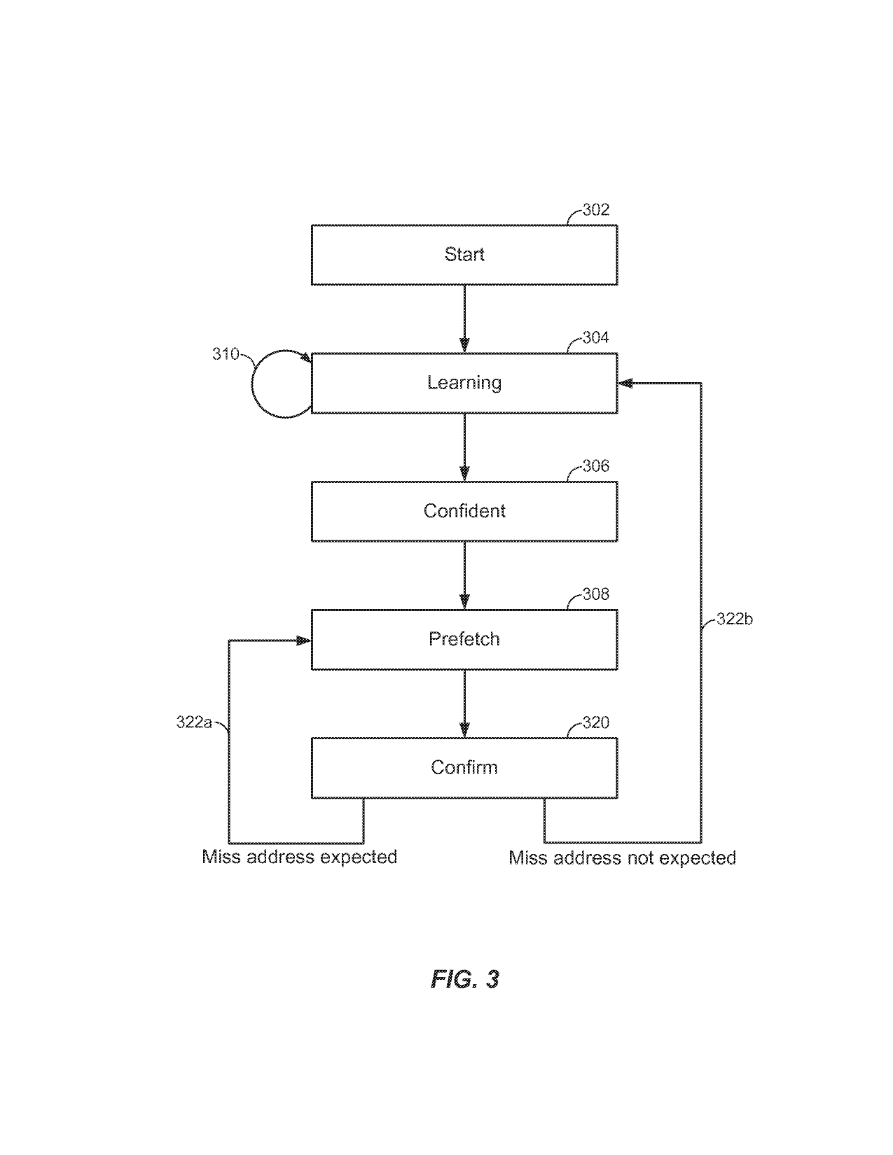

Referring now to FIG. 3, a flow chart depiction of a hardware prefetch algorithm according to exemplary embodiments is illustrated. For example, the illustrated algorithm may be employed in hardware prefetcher 206 of FIG. 2, as will be further described below.

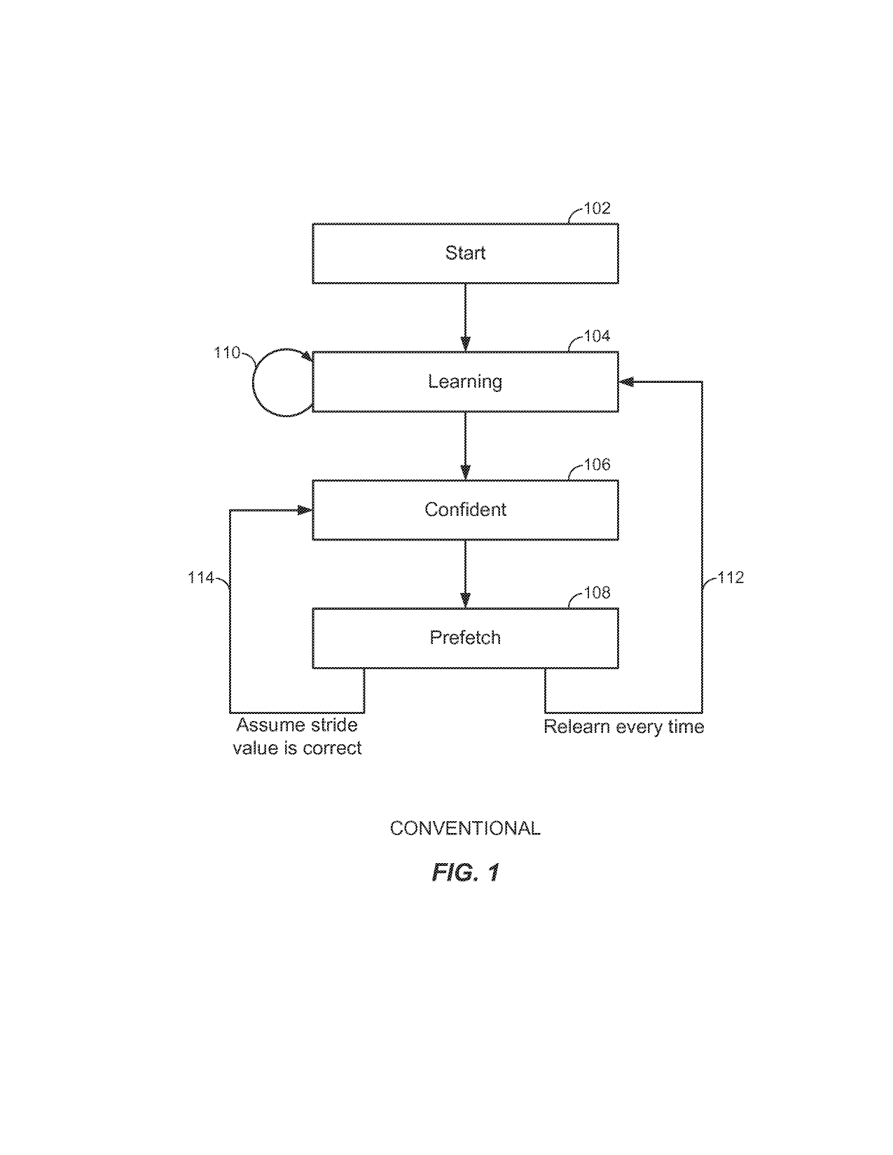

Initially, it can be seen that in comparison to FIG. 1, FIG. 3 includes an additional confirm Block 320. A detailed description of FIG. 3 will now be provided. Block 302 is a starting point where hardware prefetcher 206 may be initialized and ready to observe and learn from a new stream of information, such as misses in cache 204 for a given PC value corresponding to memory access requests from processor 202. In learning Block 304, hardware prefetcher 206 may observe a sequence of addresses in the stream and may determine a stride value. Loop 310 indicates that hardware prefetcher 206 may stay in this learning Block 304 until a desired level of confidence is achieved in the stride value. Once the desired level of confidence is achieved, hardware prefetcher 206 may transition to the confident Block 306. From confident Block 306, a triggering event, such as the next cache miss for the PC value, may trigger the transition to prefetch Block 308. At prefetch Block 308, a number N of prefetches based on the desired degree and learned stride may be issued by hardware prefetcher 206.

Now departing from conventional prefetchers illustrated in FIG. I, once the N prefetches have been issued at prefetch Block 308, hardware prefetcher 206 may transition to confirm Block 320. At confirm Block 320, hardware prefetcher 206 may wait for the next cache miss for the PC value. If the address of the next cache miss (next miss address) corresponds to the next prefetch address that would be expected based on the stride value (expected next miss address), i.e. equal to one stride value past the last prefetched address issued in prefetch Block 308, then hardware prefetcher follows the negative feedback Loop 322a to prefetch Block 308 to continue issuing prefetches with the same stride value. In other words, if the next miss address is equal to the expected next miss address based on the stride value, then relearning the stride value may be skipped.

On the other hand, if in confirm Block 320, hardware prefetcher 206 determines that the next miss address is not equal to the expected next miss address, then hardware prefetcher 206 transitions to learning Block 304 via Loop 322b. In other words, because the next miss address does not correspond to the expected next miss address, hardware prefetcher 206 recognizes that the stride value must have changed, and therefore relearning is required.

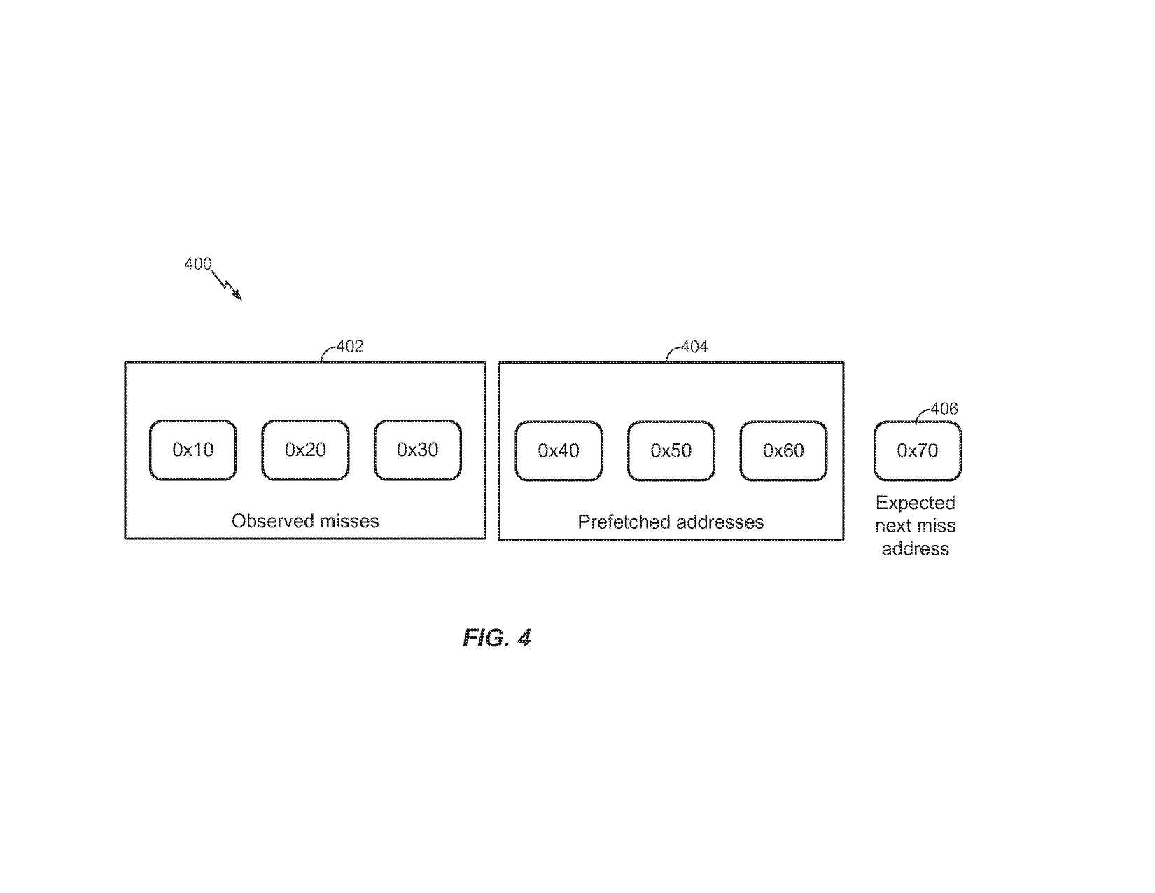

The above-described operational flow of FIG. 3 will now be applied to an exemplary method of populating cache 204 with an illustrative stream of addresses. With reference now to FIG. 4, an illustrative set of memory addresses 400 is shown. While reference is made to the address values in the description. one of ordinary skill will recognize the cases where these references to the address values herein have been used to refer to the related information or cache entries corresponding to the address values.

As shown, stream 102 comprises addresses 0x10, 0x20, and 0x30, Stream 102 may correspond to addresses of memory access requests or demand misses from processor 202 for a particular PC value. Hardware prefetcher 206 may observe addresses 0x10 and 0x20 corresponding to a first and second demand miss in learning Block 304 of FIG. 3 via Loop 310, and calculate an initial stride value of 0x10. Upon observing that the demand miss is for address 0x30, hardware prefetcher 206 may verify the initial stride value of 0x10 and move to confident Block 306.

Hardware prefetcher 206 may then issue a selected degree of prefetches for stream 404 from prefetch Block 308. As previously discussed, a degree may refer to a number of prefetches to issue based on a given stride. As shown, stream 404 has a degree of three and a stride value of 0x10. Thus stream 404 may comprise the next three addresses 0x40, 0x50, and 0x60, generated in strides of 0x10 from the last observed miss address 0x30. Hardware prefetcher 206 may then transition to confirm Block 320 and determine the expected next miss address 406 as 0x70 from the last prefetched address 0x60 and the verified initial stride value of 0x10.

Hardware prefetcher 206 remains in confirm Block 320 until the next demand miss occurs for the particular PC value in cache 204. If the address of the next demand miss (next miss address) corresponds to the expected next miss address 406 (i.e. is equal to 0x70). then hardware prefetcher 206 may confirm the verified initial stride value of 0x10, and transition to prefetch Block 308 via Loop 322b without having to relearn the stride value. However, if the next miss address does not correspond to the expected next miss address 406 (i.e. is not equal to 0x70), then hardware prefetcher 206 may determine that the verified initial stride value of 0x10 is not confirmed, and transition to learning Block 304 via Loop 322a in order to determine an alternate stride value. Once determined the alternate stride value may be verified and then used for issuing prefetches by traversing through learning Block 304, confident Block 306, and prefetch Block 308.

In this manner, hardware prefetcher 206 may populate the cache 204 by appropriately performing the steps of determining an initial stride value based on at least a first and second demand miss address (learning Block 304); verifying the initial stride value based on a third demand miss address (confident Block 306); prefetching a predetermined number of cache lines based on the verified initial stride value (prefetch Block 308); determining an expected next miss address based on the verified initial stride value and addresses of the prefetched cache lines; and confirming the verified initial stride value based on comparing the expected next miss address to a next demand miss address (confirm Block 320 and Loops 322a or 322b depending on the result of the compare operation).

Now it will be recognized that in an exceptional case, a determination in confirm Block 320 that the next miss address is not equal to the expected next miss address may also arise if the expected next miss address is already present in the cache. For example, with reference again to FIGS. 2-4, if the expected next miss address 406 (0x70) is already present in cache 204 for any reason (e.g. 0x70 may have been fetched due to a demand from a different PC value), then the stride value of 0x10 is not incorrect. However, this exceptional case may be overlooked by hardware prefetcher 206 by nevertheless transitioning to learning Block 304 via Loop 322a. While in this exceptional case, an unnecessary relearning of the stride value is performed, this leads to only a minor delay being incurred, without altering the functional correctness of exemplary embodiments. Moreover, in comparison to conventional techniques, even if this unnecessary relearning is encountered in the exceptional cases, hardware prefetcher 206 remains energy-efficient because it does not prefetch the expected next miss address and generate unnecessary memory traffic. It will be recalled that a prefetch will be issued for the expected next miss address only if hardware prefetcher 206 transitions to prefetch Block 308 via negative feedback Loop 322b if the next miss address matches the expected next miss address.

Accordingly, it will be recognized that exemplary embodiments configured in terms of the above description avoid the drawbacks of conventional hardware prefetchers shown in FIG. 1 by including confirm Block 320 to compare the next miss address with the expected next miss address and providing a negative feedback loop for issuing accurate prefetches. Therefore, exemplary embodiments also avoid unnecessary memory traffic and pollution of the cache without having to rely on expensive and complex solutions for determining accuracy by tracking the use or nonuse of prefetched data in the cache.

Moreover, it will be recognized that exemplary embodiments may be configured as described to perform prefetches for individual streams, such as for particular PC values. Accordingly exemplary embodiments may have improved accuracy as there is a high likelihood of deterministic patterns such as constant stride values to be associated with the same PC value.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for prefetching cache entries using a hardware prefetcher. Accordingly, the invention is not limited to illustrated examples and any means for performing the functionality described herein are included in embodiments of the invention.

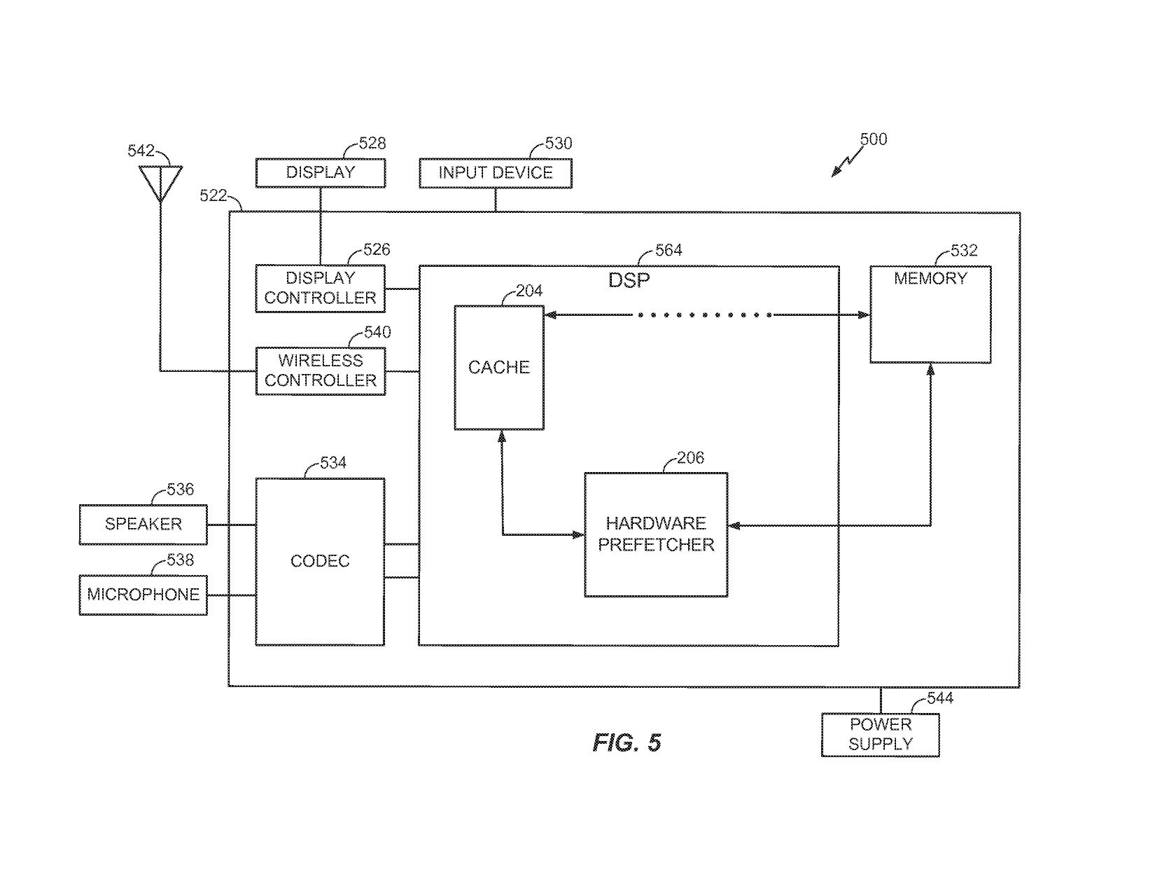

Referring to FIG. 5, a block diagram of a particular illustrative embodiment of a wireless device that includes a multi-core processor configured according to exemplary embodiments is depicted and generally designated 500. The device 500 includes a digital signal processor (DSP) 564 (or processor 202 of FIG. 2), which may include cache 204 and hardware prefetcher 206 of FIG. 2 coupled to memory 532 as shown. FIG. 5 also shows display controller 526 that is coupled to DSP 564 and to display 528. Coder/decoder (CODEC) 534 (e.g., an audio and/or voice CODEC) can be coupled to DSP 564. Other components, such as wireless controller 540 (which may include a modem) are also illustrated. Speaker 536 and microphone 538 can be coupled to CODEC 534. FIG. 5 also indicates that wireless controller 540 can be coupled to wireless antenna 542. In a particular embodiment, DSP 564, display controller 526, memory 532, CODEC 534, and wireless controller 540 are included in a system-in-package or system-on-chip device 522.

In a particular embodiment, input device 530 and power supply 544 are coupled to the system-on-chip device 522. Moreover, in a particular embodiment, as illustrated in FIG. 5, display 52$, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 depicts a wireless communications device, DSP 564 and memory 532 may also be integrated into a set-top box, a music player, a video player, an entertainment unit, a navigation device, a personal digital assistant (PDA), a fixed location data unit, or a computer. A processor (e.g., DSP 564) may also be integrated into such a device.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of populating a cache comprising:
determining an initial stride value based on at least a first and second demand miss address;
verifying the initial stride value based on a third demand miss address;
prefetching a predetermined number of cache entries based on the verified initial stride value;
determining an expected next miss address based on the verified initial stride value and addresses of the prefetched cache entries; and
confirming the verified initial stride value based on comparing the expected next miss address to a next demand miss address.

2. The method of claim 1, further comprising prefetching additional cache entries if the verified initial stride value is confirmed.

3. The method of claim 1, further comprising stalling prefetch of additional cache entries if the verified initial stride value is not confirmed.

4. The method of claim 1, further comprising determining an alternate stride value and repeating the steps of verifying, prefetching, determining, and confirming, based on the alternate stride value, if the verified initial stride value is not confirmed.

5. The method of claim 1, wherein the verified initial stride value is not confirmed if a cache entry corresponding to the expected next miss address is present in the cache.

6. A processing system comprising:
a processor;
a cache;
a memory; and
a hardware prefetcher configured to populate the cache by prefetching cache entries from the memory, wherein the hardware prefetcher comprises logic configured to:
determine an initial stride value based on at least a first and second demand miss address generated by the processor;
verify the initial stride value based on a third demand miss address generated by the processor;
prefetch a predetermined number of cache entries based on the verified initial stride value;
determine an expected next miss address based on the verified initial stride value and addresses of the prefetched cache entries; and
confirm the verified initial stride value based on comparing the expected next miss address to a next demand miss address generated by the processor.

7. The processing system of claim 6, wherein the hardware prefetcher further comprises logic configured to prefetch additional cache entries if the verified initial stride value is confirmed.

8. The processing system of claim 6, wherein the hardware prefetcher further comprises logic configured to determine an alternate stride value if the verified initial stride value is not confirmed.

9. The processing system of claim 6, integrated in at least one semiconductor die.

10. The processing system of claim 6, integrated into a device, selected from the group consisting of a set top box, music player, video player, entertainment unit, navigation device, communications device, personal digital assistant (PDA), fixed location data unit, and a computer.

11. A hardware prefetcher for populating a cache, the hardware prefetcher comprising:
logic configured to determine an initial stride value based on at least a first and second demand miss address in the cache;
logic configured to verify the initial stride value based on a third demand miss address in the cache;
logic configured to prefetch a predetermined number of cache entries into the cache based on the verified initial stride value:
logic configured to determine an expected next miss address in the cache based on the verified initial stride value and addresses of the prefetched cache entries; and
logic configured to confirm the verified initial stride value based on comparing the expected next miss address to a next demand miss address in the cache.

12. The hardware prefetcher of claim 11, further comprising logic configured to prefetch additional cache entries if the verified initial stride value is confirmed.

13. The hardware prefetcher of claim 11, further comprising logic configured to determine an alternate stride value if the verified initial stride value is not confirmed.

14. The hardware prefetcher of claim 11, integrated in at least one semiconductor die.

15. The hardware prefetcher of claim 11, integrated into a device, selected from the group consisting of a set top box, music player, video player, entertainment unit, navigation device, communications device, personal digital assistant (PDA), fixed location data unit, and a computer.

16. A system comprising:
a cache:
means for determining an initial stride value based on at least a first and second demand miss address in the cache;
means for verifying the initial stride; value based on a third demand miss address in the cache;
means for prefetching a predetermined number of cache entries into the cache, based on the verified initial stride value:
means for determining an expected next miss address in the cache based on the verified initial stride value and addresses of the prefetched cache entries; and
means for confirming the verified initial stride value based on comparing the expected next miss address to a next demand miss address in the cache.

17. The system of claim 16, further comprising means for prefetching additional cache entries into the cache if the verified initial stride value is confirmed.

18. The system of claim 16, further comprising means for stalling prefetch of additional cache entries if the verified initial stride value is not confirmed.

19. The system of claim 18, further comprising means for determining an alternate stride value.

20. A non-transitory computer-readable storage medium comprising code, which, when executed by a processor, causes the processor to perform operations for prefetching entries into a cache, the non-transitory computer-readable storage medium comprising:
code for determining an initial stride value based on at least a first and second demand miss address in the cache;
code for verifying the initial stride value based on a third demand miss address in the cache;
code for prefetching a predetermined number of cache entries into the cache, based on the verified initial stride value;
code for determining an expected next miss address in the cache based on the verified initial stride value and addresses of the prefetched cache entries; and
code for confirming the verified initial stride value based on comparing the expected next miss address to a next demand miss address in the cache.

21. The non-transitory computer-readable storage medium of claim 20, further comprising code for prefetching additional cache entries into the cache if the verified initial stride value is confirmed.

22. The non-transitory computer-readable storage medium of claim 20, further comprising code for stalling prefetch of additional cache entries if the verified initial stride value is not confirmed.

23. The non-transitory computer-readable storage medium of claim 22, further comprising code for determining an alternate stride value.
